(19) United States
(12) Patent Application Publication
(10) Pub. No.: US 2025/0106743 A1
(43) Pub. Date: Mar. 27, 2025

(54) Out-of-Service Recovery Search Method and Out-of-Service Recovery Search System Capable of Performing High Search Efficiency and Link Tracking for Cell Detection

(71) Applicant: MEDIATEK INC., Hsinchu City (TW)

(72) Inventors: Jia-Hao Wu, Hsinchu City (TW); Tzyuan Shiu, Hsinchu City (TW); Da-Wei Wang, Hsinchu City (TW); Lu-Chi Lin, Hsinchu City (TW); Mu-Chi Fang, Hsinchu City (TW); Wen-Yang Chou, Hsinchu City (TW); Tsung-Sheng Tang, Hsinchu City (TW); Chung-Pi Lee, Hsinchu City (TW)

(73) Assignee: MEDIATEK INC., Hsinchu City (TW)

(21) Appl. No.: 18/894,027

(22) Filed: Sep. 24, 2024

Related U.S. Application Data
(60) Provisional application No. 63/584,920, filed on Sep. 25, 2023.
(60) Provisional application No. 63/597,007, filed on Nov. 8, 2023.

(51) Int. Cl. H04W 48/16; H04W 56/00; H04W 84/04

(52) U.S. Cl. CPC H04W 48/16; H04W 56/001; H04W 84/042

(57) ABSTRACT

An out-of-service recovery search method includes establishing a frequency list including at least one searchable frequency, searching a suitable cell of a network according to the frequency list when the user terminal is in an out-of-service state, determining at least one first skip condition of the user terminal, performing a full-band power scan mechanism for scanning received signal strength indication (RSSIs) of user terminal supported frequency bands when the at least one first skip condition of the user terminal is absent and no suitable cell of the network is searched within the searchable frequency of the frequency list, skipping the full-band power scan mechanism when the at least one first skip condition of the user terminal is present and no suitable cell of the network is searched within the searchable frequency, and performing an RSSI sniffer for scanning a signal power of each frequency of the searchable frequency.

### CROSS REFERENCE TO RELATED APPLICATIONS

This application claims the benefit of U.S. Provisional Application No. 63/584,920, filed on Sep. 25, 2023. Further, this application claims the benefit of U.S. Provisional Application No. 63/597,007, filed on Nov. 8, 2023. The contents of these applications are incorporated herein by reference.

### BACKGROUND

Network recovery search is a critical function enabling user equipment (UE) to seamlessly reconnect to a suitable cellular network upon power-on or after being out-of-service (OOS). This process involves the UE searching for and camping on an optimal cell based on predefined network selection priorities outlined in 3GPP 23.122 standards. Moreover, efficient network recovery search is paramount for ensuring optimal user experience. Key performance indicators (KPIs) such as power consumption, recovery search time, and coverage are directly impacted by the search strategy employed. However, existing approaches often lead to suboptimal performance because they use generic strategies that fail to account for diverse operating scenarios encountered by UEs.

Therefore, developing an OOS recovery search method under different operating scenarios capable of improving the KPIs and optimizing network search strategies is an important design issue.

### SUMMARY

In an embodiment of the present invention, an out-of-service recovery search method for a user terminal is disclosed. The out-of-service recovery search method comprises establishing a frequency list comprising at least one searchable frequency by the user terminal, searching a suitable cell to camp on a network according to the frequency list by the user terminal when the user terminal is in an out-of-service state, determining at least one first skip condition of the user terminal, performing a full-band power scan mechanism for scanning received signal strength indication (RSSIs) of certain frequency bands or user terminal supported frequency bands when the at least one first skip condition of the user terminal is absent and no suitable cell of the network is searched within the searchable frequency of the frequency list, skipping the full-band power scan mechanism when the at least one first skip condition of the user terminal is present and no suitable cell of the network is searched within the searchable frequency of the frequency list, and performing an RSSI sniffer for scanning a signal power of each frequency of the searchable frequency according to the frequency list after the full-band power scan and full-band search mechanism are skipped, or they are performed but no suitable cell is found.

In another embodiment of the present invention, an out-of-service recovery search system for a user terminal is disclosed. The out-of-service recovery search system includes a network search procedure adaptor, a memory, a received signal strength indication (RSSI) sniffer, and a processor. The network search procedure adaptor is configured to control at least one search strategy. The memory is configured to save data. The processor is coupled to the network search procedure adaptor, the memory, and the RSSI sniffer. The processor establishes a frequency list saved in the memory. The frequency list comprises at least one searchable frequency. The processor searches a suitable cell of a network according to the frequency list when the user terminal is in an out-of-service state. The processor determines at least one first skip condition of the user terminal. The processor performs a full-band power scan mechanism for scanning RSSIs of certain frequency bands or user terminal supported frequency bands when the at least one first skip condition of the user terminal is absent and no suitable cell of the network is searched within the searchable frequency of the frequency list. The processor skips the full-band power scan mechanism according to the at least one search strategy controlled by the network search procedure adaptor when the at least one first skip condition of the user terminal is present and no suitable cell of the network is searched within the searchable frequency of the frequency list. The RSSI sniffer scans a signal power of each frequency of the searchable frequency according to the frequency list after the full-band power scan and full-band search mechanism are skipped, or they are performed but no suitable cell is found. The network search procedure adaptor, the memory, the RSSI sniffer, and the processor are integrated in the user terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an out-of-service recovery search system for a user terminal according to an embodiment of the present invention.

FIG. 2 is a flow chart of performing the out-of-service recovery search method by the out-of-service recovery search system in FIG. 1.

FIG. 3 is a flow chart of performing a link tracking technology for tracking a weak radio link by the user terminal of the out-of-service recovery search system in FIG. 1.

### DETAILED DESCRIPTION

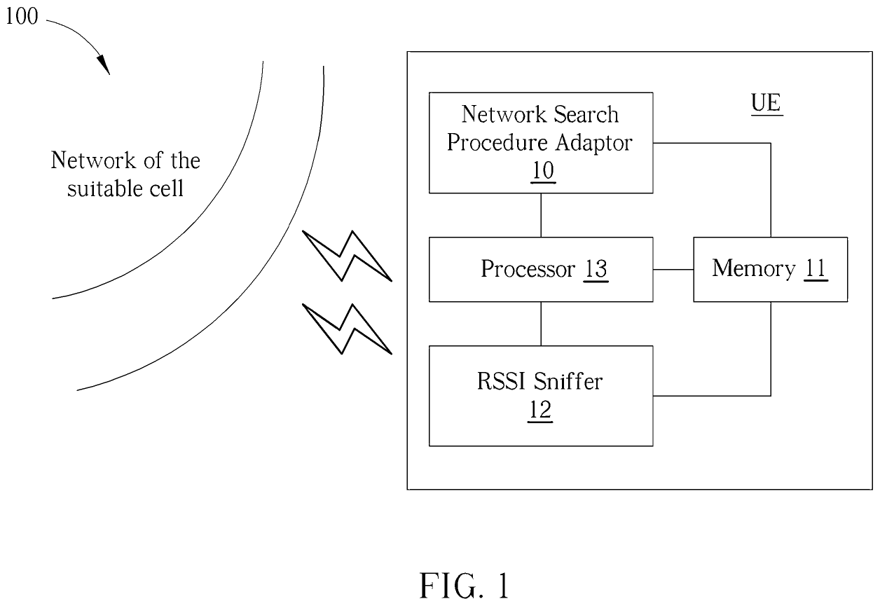

FIG. 1 is a block diagram of an out-of-service recovery search system 100 for a user terminal according to an embodiment of the present invention. The out-of-service recovery search system 100 can be used for any user terminal (or say, user equipment), such as a smartphone or a tablet. The out-of-service recovery search system 100 focuses on improving the performance metrics (Key performance indicators, KPIs) of the user terminal when it's searching for a network after losing connection. Particularly, it achieves this through several strategies, such as cross-layer search optimization, prioritizing search frequencies, and intelligent frequency selection. For example, the out-of-service recovery search system 100 can skip unnecessary searches. The user terminal can avoid performing full-band power scans and searches in certain conditions, resulting in saving energy and time. Further, the out-of-service recovery search system 100 can prioritize specific frequencies, like the one previously connected to, for faster and more efficient search. The out-of-service recovery search system 100 can skip searching on frequency bands that have signals but no suitable network cells, conserving energy and time.

In FIG. 1, the out-of-service recovery search system 100 can include a network search procedure adaptor 10, a memory 11, a received signal strength indication (RSSI) sniffer 12, and a processor 13. The network search procedure adaptor is configured to control at least one search strategy. The memory is configured to save data. The processor 13 is coupled to the network search procedure adaptor 10, the memory 11, and the RSSI sniffer 12. In the out-of-service recovery search system 100, the network search procedure adaptor 10, the memory 11, the RSSI sniffer 12, and the processor 13 can be integrated in the user terminal UE. Briefly, the processor can establish a frequency list saved in the memory 11. The frequency list includes at least one searchable frequency. The processor 13 searches a suitable cell of a network according to the frequency list when the user terminal UE is in an out-of-service state. The processor 13 can determine at least one first skip condition of the user terminal. The processor 13 performs a full-band power scan mechanism for scanning received signal strength indications (RSSIs) of certain frequency bands or user terminal UE supported frequency bands when the at least one first skip condition of the user terminal UE is absent and no suitable cell of the network is searched within the searchable frequency of the frequency list. The processor 13 can skip the full-band power scan mechanism according to the at least one search strategy controlled by the network search procedure adaptor 10 when the at least one first skip condition of the user terminal UE is present and no suitable cell of the network is searched within the searchable frequency of the frequency list. Then, the RSSI sniffer 12 scans a signal power of each frequency of the searchable frequency according to the frequency list after the full-band power scan mechanism is skipped.

Further, in the out-of-service recovery search system 100, it can improve the efficiency and power consumption of the mobile device's radio frequency (RF) components during the network search process. For example, in a power-saving mode strategy, the out-of-service recovery search system 100 can use 1RX (single receive antenna) and low power modes for specific search conditions. Therefore, the user terminal UE can reduce energy consumption. In a reduced search time strategy, the out-of-service recovery search system 100 can shorten the duration of stored carrier search and RSSI measurements. Therefore, it can save power and accelerate the search process, especially for frequencies with high priority. In an enhanced procedure strategy, the out-of-service recovery search system 100 can improve layer-one carrier search algorithm, leading to decreased power consumption and faster search completion times. In the out-of-service recovery search system 100, a deep search method for searching a weak signal (i.e., weak cell) can be introduced for enhancing a searching coverage. For example, in a weak signal search mode, the out-of-service recovery search system 100 can employ specialized search methods to detect and connect to networks with low signal quality (i.e., low Signal-to-Noise Ratio or low Reference Signal Received Power), particularly on frequencies where the user terminal UE was previously connected. Further, by analyzing the user terminal UE's connection history (link tracking log data), when the user terminal UE enters the out-of-service state, the search process can be streamlined to prioritize specific frequencies, thereby reducing the search time, and conserving power. Moreover, the out-of-service recovery search system 100 can monitor the strength and coverage of available signals. The user terminal UE can dynamically adjust its search parameters, such as a frequency range or a search frequency, resulting in optimizing power consumption and coverage. Details of performing the out-of-service recovery search method by the out-of-service recovery search system 100 are illustrated below.

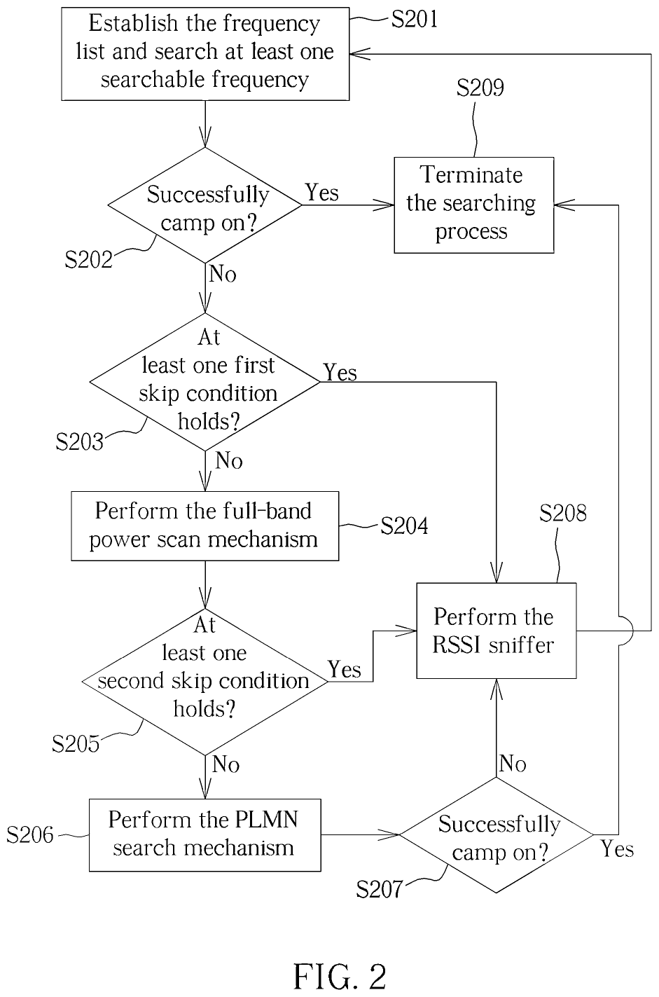

FIG. 2 is a flow chart of performing the out-of-service recovery search method by the out-of-service recovery search system 100. The out-of-service recovery search method includes step S201 to step S210. Any reasonable technology or hardware modification falls into the scope of the present invention. Step S201 to step S210 are illustrated below.
Step S201: establish the frequency list and search at least one searchable frequency;
Step S202: determine if the network is successfully camped on. If yes, go to step S209; if no, go to step S203;
Step S203: determine if at least one first skip condition holds. If yes, go to step S208, if no, go to step S204;
Step S204: perform the full-band power scan mechanism;
Step S205: determine if at least one second skip condition holds. If yes, go to step S208, of no, go to step S206;
Step S206: perform the full-band public land mobile network (PLMN) search mechanism;
Step S207: determine if the network is successfully camped on. If yes, go to step S209; if no, go to step S208;
Step S208: perform the received signal strength indication (RSSI) sniffer 12; if the RSSI sniffer 12 detects signal existed, go to step S201;
Step S209: Terminate the searching process.

After the user terminal UE enters an out-of-service state, in step S201, the processor can establish a frequency list saved in the memory 11. The frequency list can be generated according to historic statistic of signal frequencies. For example, the frequency list can include at least one ranked searchable frequency, or at least one frequency previously camped on. Then, the network search procedure adaptor 10 can search a network of a suitable cell according to the frequency list. Here, searching a network under different searchable frequencies can introduce various modes, such as a speed search mode, an accuracy search mode, or a low SNR (Signal-to-Noise Ratio) search mode. Further, some optimizations can be introduced to step S201. For example, the out-of-service recovery search system 100 can use 1RX (single receive antenna) and low power modes for specific search conditions in step S201. The out-of-service recovery search system 100 can shorten the duration of stored carrier search and RSSI sniffer window for frequencies according to priority in step S201. The out-of-service recovery search system 100 can use timing diversity for enhancing coverage, specifically in weak network previously camped on in step S201. The out-of-service recovery search system 100 can improve layer-one carrier search algorithm in step S201, leading to decreased power consumption and faster search completion times. The out-of-service recovery search system 100 can perform a link tracking technology under the out-of-service state in step S201 for skipping a full-band power scan mechanism (in step S204) and a full-band public land mobile network (PLMN) search mechanism, and further reducing a RF window of the user terminal UE.

Then, in step S202, the processor 13 can determine if the network can be successfully camped on. If the network is successfully camped on, it implies the suitable cell is found. After the suitable cell is validated, the processor 13 can terminate the searching process in step S209. If the network fails to be camped on, in step S203, the processor 13 can previously determine at least one first skip condition of the user terminal UE. Details of the “at least one first skip condition” are illustrated later. In other words, the “at least one first skip condition” can be a rule for skipping the full-band power scan mechanism (in step S204) and the PLMN search mechanism when the user terminal UE temporally enters the out-of-service state. In step S203, the processor 13 can determine if at least one first skip condition holds. When the at least one first skip condition of the user terminal UE is present, it implies that subsequent band searching processes can be skipped. Therefore, in step S208, the processor 13 can perform the RSSI sniffer 12 for scanning a signal power of each frequency of the searchable frequency according to the frequency list after the subsequent band searching processes are skipped. When the at least one first skip condition of the user terminal UE is absent, in step S204, the processor 13 can perform the full-band power scan mechanism according to the search strategy controlled by the network search procedure adaptor 10 for scanning received signal strength indications (RSSIs) of certain frequency bands or user terminal supported frequency bands. Here, the full-band power scan mechanism can introduce various modes, such as a coarse initial power scan mode or a fine initial power scan mode. Further, some optimizations can be introduced to step S204. For example, the out-of-service recovery search system 100 can use 1RX (single receive antenna) and low power modes for specific search conditions in step S204.

Then, in step S205, the processor 13 can previously determine at least one second skip condition of the user terminal. Details of the “at least one second skip condition” are illustrated later. In other words, the “at least one second skip condition” can be a rule for skipping the full-band public land mobile network (PLMN) search mechanism (in step S206). In step S205, the processor 13 can determine if at least one second skip condition holds. When the at least one second skip condition of the user terminal UE is present, it implies that a certain band or subsequent band searching processes (i.e., PLMN search mechanism) can be skipped. Therefore, the processor 13 can control the network search procedure adaptor 10 to skip the full-band PLMN search mechanism. In step S208, the processor 13 can trigger the RSSI sniffer 12 for scanning a signal power of each frequency of the searchable frequency according to the frequency list after the subsequent band searching processes are skipped. When the at least one second skip condition of the user terminal UE is absent, in step S206, the processor 13 can perform the PLMN search mechanism according to the search strategy controlled by the network search procedure adaptor 10 for searching the suitable cell of the network having an RSSI greater than an RSSI threshold. Here, the PLMN search mechanism can introduce various modes, such as a speed mode for searching carrier frequencies. Further, some optimizations can be introduced to step S206. For example, some optimizations can be introduced to step S206. For example, the out-of-service recovery search system 100 can use 1RX (single receive antenna) and low power modes for specific search conditions in step S206. Step S206 can use RSSI change detection (i.e., for detecting RSSI variations, illustrated later) for skipping PLMN search mechanism.

In step S207, the processor 13 can determine if the network can be successfully camped on. If the network is successfully camped on, it implies the suitable cell is found. After the suitable cell is validated, the processor 13 can terminate the searching process in step S209. If the network fails to be camped on, in step S203, the processor 13 can perform the RSSI sniffer 12 to scan the signal power of each frequency of the searchable frequency according to the frequency list in step S208. Here, the RSSI sniffer 12 can perform a power scan for each frequency by using 1RX (single receive antenna) and low power modes for specific search conditions. Further, the out-of-service recovery search system 100 can shorten the duration of stored carrier search and RSSI sniffer window for frequencies according to priority in step S208. If the RSSI sniffer 12 detects signal existed, go to step S201, else, continuously perform the power scan. In step S201 to step S209, instead of using a greedy search or a regular search technology, the full-band power scan mechanism and/or the PLMN search mechanism can be skipped under certain conditions. Therefore, the out-of-service recovery search system 100 can provide high efficiency of searching the suitable cell and reducing power consumption. In the out-of-service recovery search system 100, it should be understood that the network search procedure adaptor 10 can adjust the network search strategy based on factors such as link tracking, previous search results, and mobility or GPS location information provided by access points or sensors. Adjustments of the network search strategy may include decisions on skipping full-band searches, prioritizing sniffer frequencies, or any possible network parameters. Further, in the RSSI sniffer stage, different frequencies are assigned varying search priorities and search periods. Certain frequencies, such as those previously camped on or measured, undergo RSSI sniffing more frequently. For other frequencies, the RSSI sniffing frequency can be reduced. In the following, some embodiments of the first condition and the second condition, and some embodiments for optimizing step S201 to step S209 are illustrated.

Full-band power scans and full-band searches are resource-intensive processes that consume significant time and power. These operations are typically used to find lower-priority cellular networks (PLMNs) that are not included in the user terminal's prioritized search list. When the user terminal UE is out-of-service for a relatively short duration, it is likely still connected to the same network. Thus, performing a full-band search might be unnecessary. In an embodiment, the processor 13 can set a skip time length. The processor 13 can user a timer to record a time period of the user terminal UE in the out-of-service state. Here, the at least one first skip condition includes skipping the full-band power scan mechanism and the PLMN search mechanism when the time period is smaller than the skip time length.

Full-band power scans and full-band searches are processes that consume significant time and power. It is possible to optimize this by skipping the full-band search when the user terminal UE is within the same network deployment region. In an embodiment, the processor 13 can set the RSSI threshold. The processor 13 can acquire RSSI variations of the certain frequency bands or the user terminal supported frequency bands during an observation time interval. Here, the least one second skip condition of skipping the full-band PLMN search mechanism includes skipping the PLMN search mechanism when all RSSIs of the certain frequency bands or the user terminal supported frequency bands are smaller than the RSSI threshold, or the RSSI variations are substantially static. In other words, after the RSSI each band or sub-band is measured, the processor 13 can skip band or sub-band search according to RSSI measurements from the full-band power scan when at least one of the following criteria holds. (a) The RSSI is smaller than the RSSI threshold, such as −95 dBm. (b) No significant change in the RSSI pattern is introduced for each band or sub-band.

In most geographical areas, a cellular network typically utilizes a small number (e.g. one or two) of specific frequencies as the primary coverage. In an embodiment, the processor 13 can prioritize at least one first specified frequency from the at least one searchable frequency. Then, the processor 13 can reduce a first monitoring interval of monitoring the at least one first specified frequency by the RSSI sniffer 12. The processor 13 can deprioritize at least one second specified frequency from the at least one searchable frequency. The processor 13 can increase a second monitoring interval of monitoring the at least one second specified frequency by the RSSI sniffer 12. In other words, the processor 13 gives preference to stored frequencies such as those from the last camped-on cell or those with previously measured data, and shortens the RSSI sniffing interval (monitoring interval) for these frequencies, especially those associated with detected neighbor cells (NBRs). This could potentially expedite network reconnection after an out-of-service period. Further, the processor 13 reduces the priority of frequencies that have not been previously measured or camped on, and increases the RSSI sniffing interval ((monitoring interval)) for these stored frequencies to potentially conserve power.

The user terminal UE may retain some timing information from previously connected base stations even after losing connection or entering out-of-service state. In an embodiment, the processor can acquire the timing information before the user terminal UE enters the out-of-service state. The processor can shorten a carrier search radio frequency (RF) window by the user terminal UE according to the timing information when the suitable cell is detected by link tracking. Here, the timing information is acquired by recording at least one synchronization signal before entering the out-of-service state. In other words, the user terminal UE can leverage this existing timing information to reduce the search range (RF window) for finding a new carrier. The length of this reduction depends on the duration of the out-of-service state or the time elapsed since the last detected cell. Further, the user terminal UE should record the time period during which it received synchronization reference signals before an event of the out-of-service state or as detected through link tracking. Moreover, according to a recorded time and considering potential timing offsets, the user terminal UE can determine an appropriate shortened RF window for the carrier search.

If the measured RSSI of a specific frequency range surpasses a predefined threshold but no suitable cell is found, the user terminal will unnecessarily consume time and power performing repeated searches. In an embodiment, the processor 13 can label at least one frequency as at least one skipped frequency when no suitable cell is found or no suitable cell of the network is camped on for N-times. N is a positive integer. Further, the processor 13 can reset the at least one skipped frequency when the suitable cell of the network is camped on, or a time duration of labeling the at least one frequency expires. In other words, when the RSSI of a particular frequency range exceeds the specified threshold, the user terminal UE tries to initiate carrier search procedures for supported radio access technologies (RATs) such as 4G or 5G. Unfortunately, if no suitable cell is discovered after a predetermined number (N) of attempts, the user terminal UE can classify the frequency range as a “skipping range”, and assign a “skipping timer”. Moreover, once the skipping timer expires or the user terminal UE successfully camps on a network, the user terminal UE can remove the “skipping range” label from the frequency range, allowing it to be considered for searching again.

The user terminal UE can potentially utilize a stable, wide-coverage signal, such as a digital broadcast signal, to determine if it is located in a coverage hole where most radio frequency (RF) signals are obstructed. In an embodiment, the processor 13 can determine if the user terminal UE is located on a coverage hole. Specifically, a presence of the coverage hole is determined according to a variation of an RSSI of a monitored stable signal after the user terminal enters the out-of-service state. When the RSSI of the monitored stable signal is decayed over a preset level, the user terminal is located on the coverage hole. Then, the processor 13 can reduce a searching frequency range for scanning higher priority frequencies when the user terminal is located on the coverage hole. Further, for saving power, the processor 13 can increase a monitoring interval of monitoring lower priority frequencies by the RSSI sniffer 12 when the user terminal UE is located on the coverage hole. In another embodiment, the processor 13 can disable the RSSI sniffer 12. In other words, the user terminal UE can monitor and measure the RSSI of a stable signal, such as a digital broadcast signal. When the RSSI of the monitored signal drops below a predetermined threshold (preset level) after the user terminal UE enters an out-of-service state, it is considered to be in a coverage hole. If the user terminal UE is determined to be in the coverage hole, the user terminal UE can narrow the search frequency range by focusing on higher priority frequencies. Moreover, for lower priority frequencies, the user terminal UE can increase the time period for monitoring signals (sniffer interval) or disable the signal checking process entirely to conserve power.

If the user terminal UE is capable of tracking a weak radio link, it can potentially avoid the need for a comprehensive (or say, blind) search across all frequency bands. For example, in the link tracking mode, the user terminal UE can employ cell detection and system information decoding (i.e., master information block, MIB) to verify the existence of a valid cell within specified stored frequencies. When a cell is detected on a stored frequency, the following recovery search strategies can be implemented, for example, such as skipping or eliminating the need for exhaustive power scans across all bands (i.e., skip full-band scans), giving preference to frequencies with detected cells during the recovery search process (i.e., prioritize detected frequencies), shortening the interval for measuring the RSSI to enhance signal tracking (i.e., Increase RSSI monitoring), and adjusting the timing of the synchronization signal block (SSB) window and potentially reduce its duration (i.e., optimize SSB window timing). Briefly, the processor 13 can use a link tracking technology for tracking the weak radio link. Then, the processor 13 can control the network search procedure adaptor 10 for adjusting search strategies according to the weak radio link. Details of the link tracking technology for tracking the weak radio link and adjusting search strategies are illustrated later.

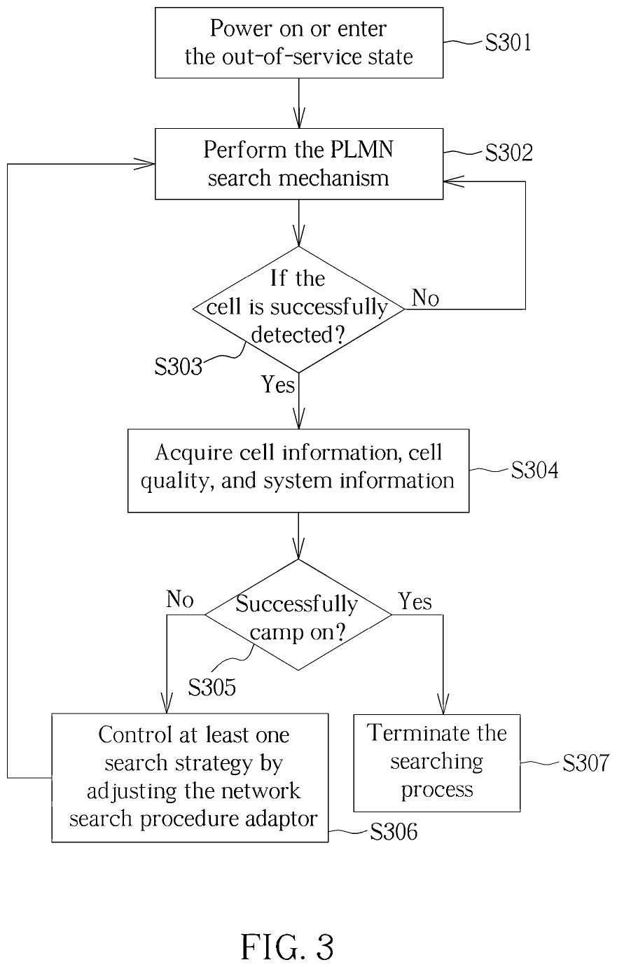

FIG. 3 is a flow chart of performing the link tracking technology for tracking the weak radio link by the user terminal UE of the out-of-service recovery search system 100. Performing the link tracking technology and adjusting search strategies includes step S301 to step S306. Any reasonable technology or hardware modification falls into the scope of the present invention. Step S301 to step S307 are illustrated below.
Step S301: power on or enter the out-of-service state;
Step S302: perform the full-band public land mobile network (PLMN) search mechanism;
Step S303: determine if the cell is successfully detected. If yes, go to step S304; if no, go to step S301;
Step S304: acquire cell information, cell quality, and system information;
Step S305: determine if the network is successfully camped on. If yes, go to step S307; if no, go to step S306;
Step S306: control at least one search strategy by adjusting the network search procedure adaptor;
Step S307: terminate the searching process.

In step S301, the user terminal UE is turned on, or enters the out-of-service state. No service and network is available. Then, in step S302, the processor 13 can perform the full-band PLMN search mechanism and/or performing the full-band power scan mechanism according to at least one search strategy controlled by the network search procedure adaptor 10 for tracking the at least one detectable cell having the weak radio link. In step S303, the processor 13 tries to detect a cell according to the weak radio link. Further, the processor 13 determines if the cell is successfully detected. In the user terminal UE fails to detect the cell, the processor 13 continuously performs the full-band PLMN search mechanism and/or performing the full-band power scan mechanism in step S302. If the cell is successfully detected, in step S304, the processor 13 can acquire cell information, cell quality, and system information for validating the cell. Further, in step S305, the processor 13 tries to camp on the weak radio link of the cell when the cell is successfully validated. Further, the processor 13 determines if the cell is successfully camped on. If the cell is successfully camped on, in step S307, the processor 13 terminates the searching process. If the user terminal UE fails to camp on the weak radio link of the cell, in step S306, the processor 13 can control the at least one search strategy by adjusting the network search procedure adaptor 10. Then, the processor 13 can use the link tracking technology for re-tracking the weak radio link according to the at least one “adjusted” search strategy. As previously illustrated, the at least one search strategy can include preferring the RSSI sniffer to scanning the signal power of the each frequency of the searchable frequency, skipping the full-band power scan mechanism and a full-band public land mobile network (PLMN) search mechanism, and shortening a carrier search radio frequency (RF) window. Further, in another embodiment, the at least one search strategy can include but not limited to the following modes. (A) Determine the order in which stored frequencies or different wireless technologies (RATs) are searched. (B) Choose the appropriate cell search mode, such as speed search, normal search, or deep search, based on specific conditions. (C) Set a frequency of the RSSI measurements for different frequencies or RATs during a monitoring phase. (D) Establish the RSSI threshold for different frequencies or RATs during the monitoring phase. (E) Schedule full-band power scans and searches, including options to skip these processes for certain periods or under specific conditions. (F) Enable or disable different stages of the network search process, such as the initial search, monitoring phase, or the RSSI sniffer. Further, as previously mentioned, the frequency list includes the at least one searchable frequency. Particularly, the processor 13 can update the frequency list according to at least one recently camped on frequency, at least one high priority frequencies available on a coverage region of the user terminal, and/or at least one frequency of a weak radio link searched by the link tracking technology. After the frequency list is updated, efficiency of the out-of-service recovery search system 100 can be improved.

Further, when the user terminal UE operates in a Non-Standalone (NSA) network, it records the paired frequencies of LTE (Long Term Evolution) and NR (New Radio). If the user terminal UE enters the out-of-service state in the NSA network, it will search for both LTE and NR frequencies previously recorded. If the user terminal UE detects an NR cell but not an LTE cell within the recorded frequencies in the NSA network, the corresponding NR frequency is considered to have a track-able NR link. If this track-able NR link belongs to a paired NSA frequency set, the network search procedure can be adjusted. In another scenario, when the user terminal UE operates in a Redcap network, it records the frequencies supporting Redcap for both its current cell and neighboring cells. If the user terminal UE enters the out of service state and encounters a non-Redcap cell during a stored frequency search phase, the corresponding frequency is considered to have a track-able link. If the frequency having the track-able link supports the Redcap cell, the network search procedure can be adjusted. Any reasonable application or technology for various scenarios falls into the scope of the present invention.

To sum up, the present invention provides an out-of-service recovery search system and out-of-service recovery search method for improving the efficiency and reducing power consumption of a user terminal during network search. The system incorporates a network search procedure adaptor, memory, RSSI sniffer, and processor for executing various search strategies. By employing techniques such as cross-layer search optimization, prioritizing search frequencies, and intelligent frequency selection, the system effectively reduces search time and power consumption. The system further enhances search performance through power-saving modes, reduced search time strategies, enhanced procedure strategies, and a deep search method for weak signals. Additionally, the system utilizes link tracking technology to optimize search parameters based on the user terminal's connection history. Overall, the invention offers a robust solution for expediting network reconnection and minimizing power consumption in user terminals experiencing out-of-service states.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An out-of-service recovery search method for a user terminal, comprising:
establishing a frequency list comprising at least one searchable frequency by the user terminal;
searching a suitable cell of a network according to the frequency list by the user terminal when the user terminal is in an out-of-service state;
determining at least one first skip condition of the user terminal;
performing a full-band power scan mechanism for scanning received signal strength indication (RSSIs) of certain frequency bands or user terminal supported frequency bands when the at least one first skip condition of the user terminal is absent and no suitable cell of the network is searched within the searchable frequency of the frequency list;
skipping the full-band power scan mechanism when the at least one first skip condition of the user terminal is present and no suitable cell of the network is searched within the searchable frequency of the frequency list; and
performing an RSSI sniffer for scanning a signal power of each frequency of the searchable frequency according to the frequency list after the full-band power scan mechanism is skipped.

2. The method of claim 1, further comprising:
determining at least one second skip condition of the user terminal;
performing a full-band public land mobile network (PLMN) search mechanism for searching the suitable cell of the network having an RSSI greater than an RSSI threshold when the at least one second skip condition is absent; and
skipping a the certain band or the full-band PLMN search mechanism when the at least one second skip condition of the user terminal is present.

3. The method of claim 2, further comprising:
camping on the suitable cell of the network by the user terminal when the suitable cell of the network is successfully searched and validated; and
performing the RSSI sniffer for scanning the signal power of each frequency of the searchable frequency according to the frequency list when the at least one first skip condition or the at least one second skip condition is present.

4. The method of claim 2, further comprising:
setting a skip time length; and
recording a time period of the user terminal in the out-of-service state;
wherein the at least one first skip condition of skipping the full-band power scan mechanism, is skipping the full-band power scan mechanism and the PLMN search mechanism when the time period is smaller than the skip time length.

5. The method of claim 2, further comprising:
setting the RSSI threshold; and
acquiring RSSI variations of the certain frequency bands or the user terminal supported frequency bands during an observation time interval;
wherein the least one second skip condition of skipping the certain band or the full-band PLMN search mechanism, is skipping the PLMN search mechanism when all RSSIs of the certain frequency bands or the user terminal supported frequency bands are smaller than the RSSI threshold, or the RSSI variations are substantially static.

6. The method of claim 1, further comprising:
prioritizing at least one first specified frequency from the at least one searchable frequency;
reducing a first monitoring interval of monitoring the at least one first specified frequency by the RSSI sniffer;
deprioritizing at least one second specified frequency from the at least one searchable frequency; and
increasing a second monitoring interval of monitoring the at least one second specified frequency by the RSSI sniffer.

7. The method of claim 1, further comprising:
acquiring timing information before the user terminal is in the out-of-service state; and
shortening a carrier search radio frequency (RF) window by the user terminal according to timing information when the suitable cell is detected by link tracking;
wherein the timing information is acquired by recording at least one synchronization signal before entering the out-of-service state.

8. The method of claim 1, further comprising:
labeling at least one frequency as at least one skipped frequency when no suitable cell is found or no suitable cell of the network is camped on for N-times; and
resetting the at least one skipped frequency when the suitable cell of the network is camped on, or a time duration of labeling the at least one frequency expires;
wherein N is a positive integer.

9. The method of claim 1, further comprising:
determining if the user terminal is located on a coverage hole;
reducing a searching frequency range for scanning higher priority frequencies when the user terminal is located on the coverage hole; and
increasing a monitoring interval of monitoring lower priority frequencies by the RSSI sniffer, or disabling the RSSI sniffer when the user terminal is located on the coverage hole.

10. The method of claim 9, wherein a presence of the coverage hole is determined according to a variation of an RSSI of a monitored stable signal after the user terminal enters the out-of-service state, and when the RSSI of the monitored stable signal is decayed over a preset level, the user terminal is located on the coverage hole.

11. The method of claim 1, further comprising:
using a link tracking technology for tracking a weak radio link by the user terminal; and
adjusting a network search procedure adaptor according to the weak radio link.

12. The method of claim 11, wherein using the link tracking technology for tracking the weak radio link by the user terminal, is performing a technology of searching the network according to the frequency list, performing the full-band power scan mechanism, and/or performing a full-band public land mobile network (PLMN) search mechanism for tracking at least one detectable cell having the weak radio link.

13. The method of claim 11, further comprising:
detecting a cell according to the weak radio link by the user terminal;
acquiring cell information, cell quality, and system information for validating the cell when the cell is successfully detected; and
camping on the weak radio link of the cell when the cell is successfully validated.

14. The method of claim 13, further comprising:
controlling at least one search strategy by adjusting the network search procedure adaptor when the user terminal fails to camp on the weak radio link of the cell; and
using the link tracking technology for re-tracking the weak radio link by the user terminal according to the at least one search strategy.

15. The method of claim 14, wherein controlling the at least one search strategy comprises:
preferring the RSSI sniffer to scan the signal power of the each frequency of the searchable frequency;
skipping the full-band power scan mechanism and a full-band public land mobile network (PLMN) search mechanism; and
shortening a carrier search radio frequency (RF) window by the user terminal.

16. The method of claim 1, further comprising:
updating the frequency list according to at least one recently camped on frequency, at least one high priority frequencies available on a coverage region of the user terminal, and/or at least one frequency of a weak radio link searched by a link tracking technology.

17. An out-of-service recovery search system for a user terminal, comprising:
a network search procedure adaptor configured to control at least one search strategy;
a memory configured to store data;
a received signal strength indication (RSSI) sniffer; and
a processor coupled to the network search procedure adaptor, the memory, and the RSSI sniffer;
wherein the processor establishes a frequency list stored in the memory, the frequency list comprises at least one searchable frequency, the processor searches a suitable cell of a network according to the frequency list when the user terminal is in an out-of-service state, the processor determines at least one first skip condition of the user terminal, the processor performs a full-band power scan mechanism for scanning received signal strength indication (RSSIs) of certain frequency bands or user terminal supported frequency bands when the at least one first skip condition of the user terminal is absent and no suitable cell of the network is searched within the searchable frequency of the frequency list, the processor skips the full-band power scan mechanism according to the at least one search strategy controlled by the network search procedure adaptor when the at least one first skip condition of the user terminal is present and no suitable cell of the network is searched within the searchable frequency of the frequency list, the RSSI sniffer scans a signal power of each frequency of the searchable frequency according to the frequency list after the full-band power scan mechanism is skipped, and the network search procedure adaptor, the memory, the RSSI sniffer, and the processor are integrated in the user terminal.

18. The system of claim 17, wherein the processor determines at least one second skip condition of the user terminal, the processor performs a full-band public land mobile network (PLMN) search mechanism for searching the suitable cell of the network having an RSSI greater than an RSSI threshold when the at least one second skip condition is absent, and the processor skips the full-band PLMN search mechanism according to the at least one search strategy controlled by the network search procedure adaptor when the at least one second skip condition of the user terminal is present.

19. The system of claim 17, wherein the processor camps on the suitable cell of the network when the suitable cell of the network is successfully searched and validated, and the RSSI sniffer scans the signal power of each frequency of the searchable frequency according to the frequency list when the at least one first skip condition or the at least one second skip condition is present.

20. The system of claim 17, wherein the processor sets a skip time length, the processor records a time period of the user terminal in the out-of-service state, and the processor skips the full-band power scan mechanism and the PLMN search mechanism according to the at least one search strategy controlled by the network search procedure adaptor when the time period is smaller than the skip time length.
